(19) United States
(12) Patent Application Publication
(10) Pub. No.: US 2011/0168096 A1
(43) Pub. Date: Jul. 14, 2011

(54) METHOD AND APPARATUS FOR POSITIONING A MILKING CUP ON A TEAT OF AN ANIMAL

(76) Inventors: Elmar Nieswand, Herne (DE); Andreas Springer, Beckum (DE); Timm Krebs, Oelde (DE); Reinhold Knoche, Beckum-Vellern (DE)

(21) Appl. No.: 12/737,599

(22) PCT Filed: Jul. 20, 2009
(86) PCT No.: PCT/EP2009/059311

§ 371 Date: Mar. 1, 2011

(30) Foreign Application Priority Data
Jul. 29, 2008 (DE) 10 2008 035 384.1

(51) Int. Cl. A01J 5/017; A01J 5/007

(52) U.S. Cl. 119/14.02; 119/14.08

(57) ABSTRACT

Methods and apparatus for positioning milking cups on respective teats of a milk-yielding animal by; generating a 3D direct recording of at least one of the milking cups and at least one of the teats of the milk-yielding animal, determining a relative distance between the milking cup and the teat from the 3D direct recording using an image processing device, using a control device to process data about the relative distance determination and then calculate a drive movement for one or more actuators for moving the milking cup(s) and reducing the relative distance between a milking cup and a respective teat, carrying out the drive movement provided that an error does not occur, and making at least one 3D direct recording for being evaluated.

### FIELD AND BACKGROUND OF THE INVENTION

A method and apparatus for positioning a milking cup on a teat of an animal

The invention relates to a method for positioning at least one milking cup on a teat of an animal, and an apparatus for performing the method.

It is a serious problem of milking robots to determine the position of teats of the animal to be milked in a quick and reliable way. Since a milking robot is used on living animals, it must especially be capable of recognizing physiological differences between the animals and detecting unforeseeable movements of the animals and considering these in the determination of the position of the teat.

A generic method and a generic apparatus are known from DE 103 51 549 A1. It is proposed in this specification to determine the coordinates of a teat in space and optionally the coordinates of a milk cup in space with the help of a recognition device, and to then move the milk cup to the location of the teat depending on this measurement and to position the cup on the teat. This solution has generally proven its worth, but it requires an especially precisely working measuring device for the absolute determination of the positions in space and a high computing power.

The currently used milking robots usually use a teat-finding apparatus which works with the help of a camera and a laser. A laser triangulation system is realized with the help of these components which is arranged on the movable parts of the milking robot.

The camera recognizes the reflection of the red laser light and the teat position can be calculated on the basis of the synchronized movements of the actuators of the milking robot. In order to position the milking cup, the known apparatus must also know in this case too the absolute position of the teat cup opening. This means that there must be a very high precise correlation between the elements of the robot kinematics (i.e. especially the parts of the kinematics which are actuated by the actuators), the milk cup opening, teat-finding sensor and the chosen teat.

In order to achieve this high precision, relatively expensive position sensors and encoders must be used, and a very precise calibration of the entire system is necessary.

When a cow kicks against the mechanism of the milking robot, this can further lead to a mechanical deviation, as a consequence of which the predetermined absolute position will differ from the stored calibrated position. In the worst case it may even be possible that a complete new calibration of the system is required by the maintenance service offered by the producer.

In order to solve this problem it disclosed in WO 2007/104 124 to record the teats and the milking cup(s) in a common 3D direct recording and to perform the measurement of the position of the one or more teats with respect to the milking cup or cups as a relative measurement. In this way, the measurement and the positioning process are considerably simplified.

### SUMMARY OF THE INVENTION

In view of this background, it is the object of the invention to provide a further optimized method and a further optimized apparatus for positioning a milking cup on a teat of an animal.

The invention provides a method for positioning one or more milking cups on one or more teats of a milk-yielding animal, that includes the following steps:

A: A perspective 3D direct recording is made of the at least one or more milking cups and the one or more teats of the milk-yielding animal;
B: the relative distance between the milking cup(s) and the teat(s) is then determined from the 3D direct recording using an image processing device;
C: a control device uses the distance determination from step B to calculate a drive movement for one or more actuators for moving the milking cup(s), which movement must be respectively carried out by the milking cup(s) and is used to reduce the relative distance determined between the milking cup(s) and the teats;
D: the drive movement is carried out and completed, provided that an error does not occur;
E: one or more of the 3D direct recordings made is/are evaluated using diagnosis and/or is/are stored for diagnosis and/or is/are output.

Preferably, the storing or outputting of the 3D direct recording occurs at least during the occurrence of an error in step D.

Preferably, an alarm is output and/or the drive movement is terminated in the event of an error.

It is appropriate and advantageous to ensure secure operation if in step B there is a partly computer-supported diagnosis of the 3D recording made. As a result, it is possible to perform in step B a diagnosis of the performed 3D recording on the basis of an animal-specific comparison with pre-stored data, especially on the basis of comparison with data of earlier drive processes.

The drive movement of the milking cups (the at least one milking cup or the several milking cups) comprises a triggering of the robot kinematics required for moving and aligning the milking cups, i.e. usually a triggering of the actuator(s) of the support arm for the milking unit and/or a triggering of the actuator for the milking cup.

The 3D camera (3D direct camera) allows taking a snapshot which jointly shows both the target (the teats) and the milking cups.

The apparatus consists of the 3D direct camera and the image processing and control device for the actuators, wherein the latter device can be combined on the hardware and software side into a device, or it can consist of separate devices.

The 3D camera produces a perspective view of the udder (oblique from below) and the teat cup or milking cup. A relative distance measurement between the teats and the milking cups is then performed by means of the recording. The control of the axes is activated by these data and the teat cup moved relative to the teat. Preferably, the teat cups are positioned in a simple and targeted way by continuous new calculation of the relative current distances from new recordings.

If a positioning process should not be performed successfully after several attempts, at least one of the 3D direct recordings which should be used for positioning will be stored in this case of error in the camera system or at another point of the control apparatus of the milking robot. Should a positioning process be interrupted without any success or take especially long, the image can also be sent with a respective error code to a herd management system (a superordinate computer with respective programs). The farmer can then perform a diagnosis there for example in order to determine why the positioning process could not be performed automatically on the respective animal. It is possible that the diagnosis will reveal that the animal is received better in a manual positioning group as a result of extraordinary udder geometry.

It is possible that the diagnosis occurs on site in an input and output terminal of the milking robot. Preferably, the diagnosis is performed as a remote diagnosis, especially via the Internet.

The invention is described below in closer detail by reference to an embodiment shown in the drawings.

### BRIEF DESCRIPTION OF THE DRAWINGS

FIG. 1a shows a photo-like 3D direct recording of an udder of an animal;

FIG. 1b shows an outline drawing produced from the recording FIG. 1;

FIG. 2 shows a schematic view of a 3D direct recording of the udder of an animal and the milking cups of a milking unit; and

FIG. 3 shows a schematic view of a part of an apparatus in accordance with the invention.

### DETAILED DESCRIPTION OF THE PREFERRED EMBODIMENTS

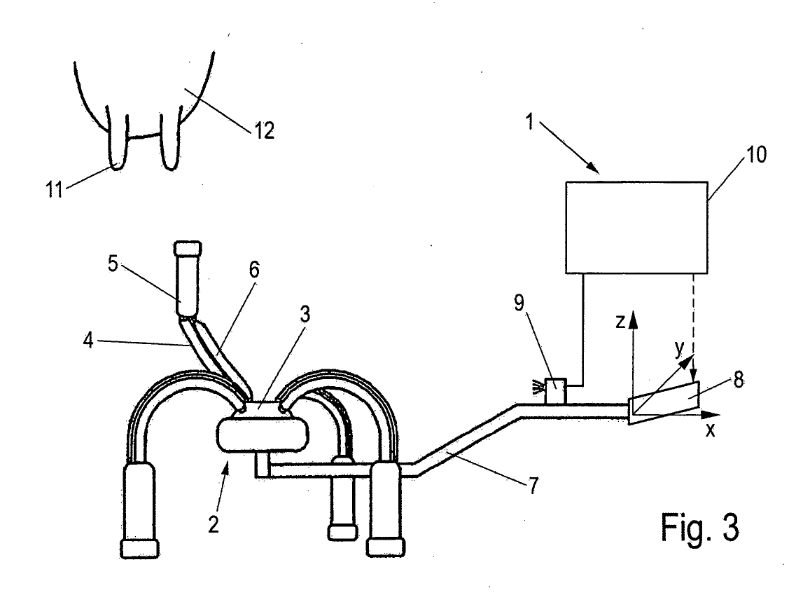

FIG. 3 shows a part of an apparatus 1 in accordance with the invention for positioning a milking cup on a teat of an animal, which milking cup is a part of an automatic milking robot which is not shown here in closer detail and which comprises at least one or more milking positions for milking milk-yielding animals.

Apparatus 1 comprises in a preferable embodiment a milking unit 2 which comprises a milk collecting piece 3 which is connected via short milking hoses 4 with milking cups 5. At least one actuator 6 is further respectively associated with the short milking hoses 4, with which the short milking hoses 4 and thus the milking cups 5 can each be moved from a lowered position to a lifted position. In FIG. 3, some of the milking cups 5 are in the lowered position and one of the milking cups 5 is in the lifted position.

The milking unit 2 is arranged on an integral or multi-part support arm 7, to which at least one or several of the actuators 8 are associated, which allow moving the support arm 7 on a basic structure (not shown in closer detail) at the milking position in a predetermined spatial section in the three spatial dimensions X, Y and Z.

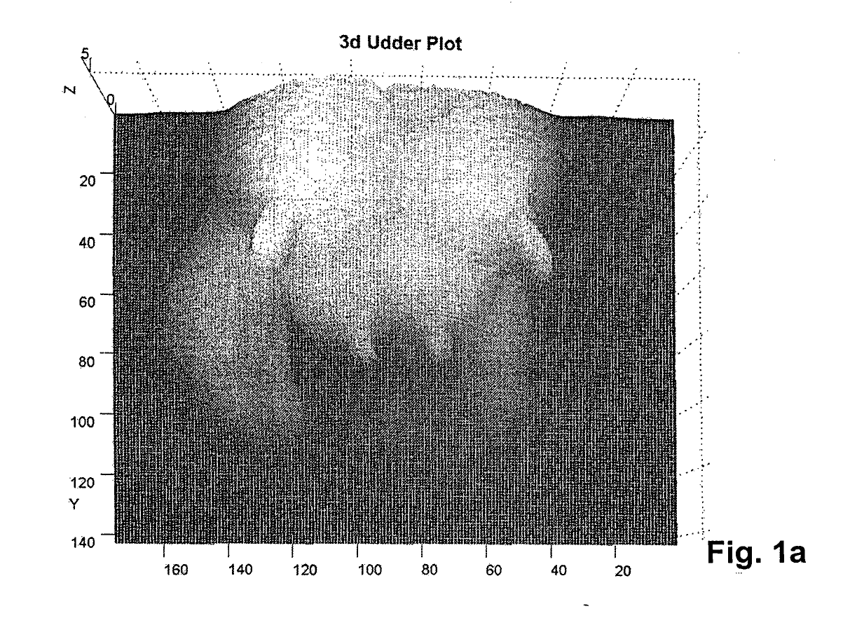

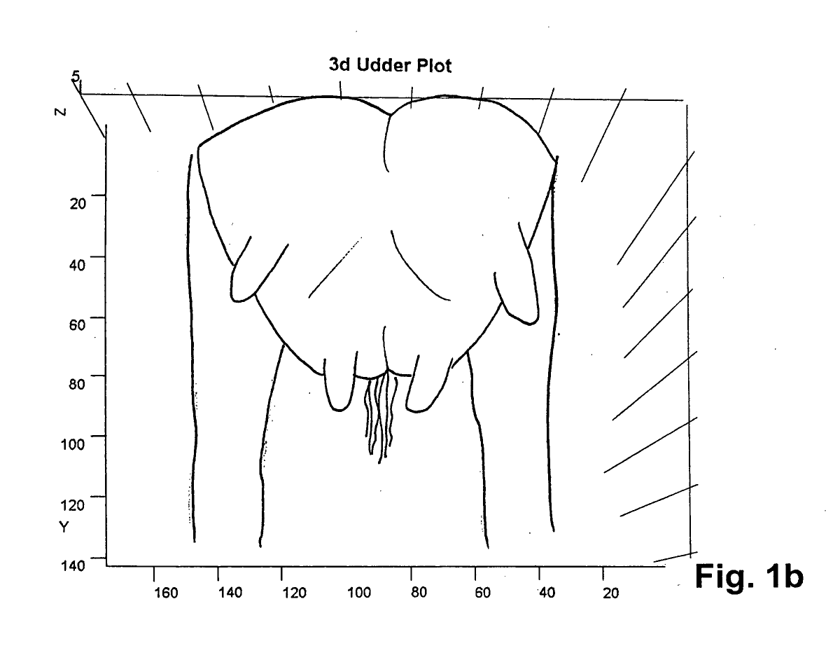

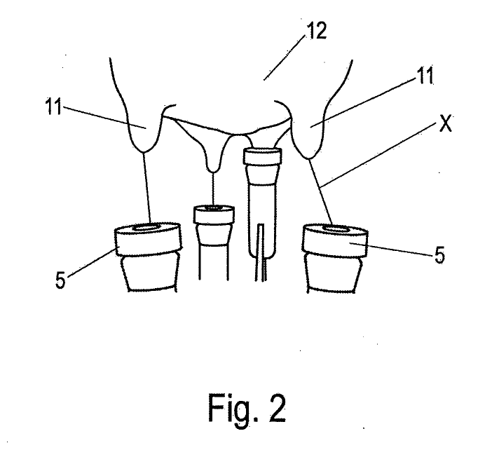

A 3D direct camera is preferably arranged on the support arm 7 as a recognition device, which camera comprises an image processing and control device 10 and/or is connected to such a one, which processing and control device evaluates the recordings of the 3D direct camera 9 and calculates control movements for the actuators 6 and/or 8 from the recordings and triggers the actuators accordingly. The recordings are optionally also stored. As can be recognized from the realistic recording of FIG. 1a in cooperation with the rather schematic recording of FIG. 2 and the outline drawing of FIG. 1b which is produced merely for reasons of clarity of the illustration, a spatial system of coordinates can be placed quasi directly in the 3D direct recording, from which the relative distance X between the teat and the respective milking cups can be determined.

The evaluation and control device can be a part of a superordinate control apparatus which is used for monitoring and controlling the entire operation of the milking robot. A decentralised modular configuration of the milking robot and especially the control apparatus of the milking robot is preferable, in which various autonomous computers for controlling respectively autonomous functional areas are connected to a central data bus (e.g. Ethernet) of the milking robot, with one of these functional areas comprising automatic teat finding and the automatic positioning of the milking cups on the found teats.

In order to position the milking cups 5 on the teats 11 of an udder 12 of an animal that will be milked and has entered the milking robot, a 3D direct recording is made at first of the milking cups 5 and the udder of animal that is to be milked and is disposed in the milking robot (see FIGS. 1 and 2). Preferably, the recording is made from a position obliquely from below the teats. Preferably, the recording with the 3D direct camera 9 is made from a predetermined basic position which can be determined empirically and which usually allows making a recording which shows both the teats of the animals and the milking cups.

The relative distance between the milking cups 5 and the teats 11 is then directly determined from the 3D direct recording without determining the position of the teats 11 in space absolutely. A drive movement to be performed by the robot kinematics on the milking unit or the milking cup(s) 5 is calculated by a control device with the help of this determination of distance, which drive movement is necessary to reduce the distance between the milking cup(s) 5 and the teat(s) 11. In order to detect unforeseeable movements of the animal and in order to optionally compensate these, it is appropriate to perform the minimization of the distance between the teat cups 5 and the teats in a controlled manner, which means that the 3D direct recordings are made repeatedly, e.g. in a predetermined time grid, in order to always detect or determine the relative distance between the milking cup(s) 5 and the teat(s) 11 as the variable to be minimized, and in order to determine actuating signals from the determined variables for the actuator(s), with which the position of the milking cups 5 in space can be changed and in order to respectively trigger the actuators of the robot kinematics accordingly, which are the actuators 6 and 8 for moving the milking cups 5 and the support arm 7.

According to a preferred embodiment, the milking cup(s) 5 is/are moved to the lifted position in their entirety right at the beginning of the positioning process or in any case after their first rough alignment of the support arm 7 after a first recording (see FIG. 2).

It is then determined by means of diagnostics whether all teats 11 of the animal and all milking cups 6 for milking the animal are shown on the 3D direct recording. Positioning of the milking cups only occurs when a relative distance information can be determined from the recording between all known teats and at least one of the milking cups (analogously to FIG. 2, where one of the milking cups 5 has already been positioned on one of the teats 11).

If it is not possible from the effected recording or after further optional recordings to determine all teats 11 of an animal by way of diagnosis after a movement of the support arm 7 to one or several other positions, the positioning process can be terminated and an error signal can optionally be output.

The positioning process can further be terminated and optionally an error signal be output and preferably at least one of the recordings be stored if another fault is determined by computer support in a diagnostic manner from the 3D direct recording or by a user, e.g. a missing (squashed) teat or a sick teat or the like.

It is especially advantageous to optionally store the recording or recordings which were made with this fault or any other potential fault in order to perform optional further diagnostics on the basis of these recordings. It is thus possible for the farmer under certain circumstances to determine on the basis of the recording whether the animal should be moved to a group of animals to be milked by hand or whether it concerns an extremely dirty animal or an injured animal.

Diagnosis can occur on-site on an input and output terminal of the milking robot or via the Internet for example within the scope of remote diagnosis. There can also be a diagnosis by comparison with pre-stored data with the device 10 in a directly computer-supported manner. Diagnosis which is enabled by the storage of the recordings of the teat-finding apparatus considerably facilitates the operation of milking robot.

Finally, the invention also allows determining the alignment of the teats in space. If it deviates strongly from the vertical line it is possible to align the milking cups 5 to the teats 11 on the basis of this alignment information.

1. A method for positioning a milking cup on a teat of a milk-yielding animal, the method comprising the steps of:
a) generating a 3D direct recording of the milking cup and the teat of the milk-yielding animal;
b) determining a relative distance between the milking cup and the teat from the 3D direct recording using an image processing device;
c) calculating with a control device a drive movement for an actuator for moving the milking cup, toward the teat;
d) carrying out and completing the drive movement; and/or
e) storing the 3D direct recording.

2. The method according to claim 1, and further comprising the step of:
determining whether there is an error in the calculated drive movement prior to the step of storing the 3D direct recording.

3. The method according to claim 1, and further comprising the step of:
diagnosing with a computer the stored 3D direct recording to determine whether there is an error in the calculated drive movement.

4. The method according to claim 1, wherein the step of determining a relative distance between the milking cup and the teat, further comprises the step of:
comparing the 3D direct recording with pre-stored data about the milk-yielding animal.

5. The method according to claim 1, and further comprising the step of:
generating an alarm after an occurrence of an error during the step of carrying out and completing the drive movement.

6. The method according to claim 1, wherein the step of generating the 3D direct recording comprises the step of:
generating the 3D direct recording from a position beneath the teat of the milk-yielding animal.

7. The method according to claim 1, and further comprising the steps of:
comparing the 3D direct recording stored 3D direct recording of the same milk-yielding animal to obtain a 3D direct recording comparison; and
determining from the 3D direct recording comparison whether the milk-yielding animal is suitable for milking.

8. The method according to claim 1, and further comprising the step of:
diagnosing the 3D direct recording with a computer to determine whether the milk-yielding animal is suitable for milking with a milking robot.

9. The method according to claim 1, and further comprising the step of:
remotely diagnosing the 3D direct image to determine whether the milk-yielding animal is suitable for milking.

10. The method according to claim 9, wherein the step of remotely diagnosing the 3D direct image comprises the step of:
transmitting data corresponding to the 3D direct image via the Internet.

11. The method according to claim 1, and further comprising the steps of:
determining an alignment angle of the teat and a second teat of the milk-yielding animal; and
aligning the milking cup and a second milking cup with the angle of the teat and the second teat, respectively.

12. The method according to claim 1, and further comprising the steps of:
determining whether the teat and a second teat of the milk-yielding animal, and the milking cup and a second milking cup corresponding to the second teat are shown in the 3D direct recording; and
calculating the drive movement only if relative distance information can be determined from the 3D direct recording between each teat and its respective milking cup.

13. The method according to claim 1, wherein the step of calculating a drive movement comprises the step of:
calculating a drive movement to be completed in a predetermined time period.

14. The method according to claim 1, wherein the step of generating a 3D direct recording comprises the step of generating a perspective 3D direct recording.

15. The method according to claim 1, and further comprising the step of:
terminating the step of carrying out and completing the drive movement in the event there is a fault with the teat as determined by the 3D direct recording.

16. Apparatus for positioning a milking cup on a teat of a milk-yielding animal, the apparatus comprising:
a 3D direct camera;
an image processing and control device programmed to use a 3D direct recording from the 3D direct camera to; determine a relative distance between milking cup and the teat of the milk-yielding animal, determine and perform a drive movement of the milking cup toward the teat, and evaluate and store the 3D direct recording.

17. A milking robot for positioning a milking cup on a teat of a milk-yielding animal, the apparatus comprising:
a 3D direct camera;
an image processing and control device programmed to use a 3D direct recording from the 3D direct camera to determine a relative distance between the milking cup and the teat of the milk-yielding animal, to determine and perform a drive movement of the milking cup toward the teat, and to evaluate the 3D direct recording.

18. The milking robot, according to claim 17, wherein the control apparatus is modular.

19. The method according to claim 1, wherein the step of determining a relative distance between the milking cup and the teat comprises the step of:
comparing the 3D direct recording with pre-stored data of a previous drive movement of the milking cup on the teat of that milk-yielding animal.

20. The method according to claim 1, and further comprising the step of:
terminating the step of carrying out and completing the drive movement when an error during the drive movement is detected.
